(19) United States
(12) Patent Application Publication
(10) Pub. No.: US 2014/0218343 A1
(43) Pub. Date: Aug. 7, 2014

(54) STYLUS SENSITIVE DEVICE WITH HOVER OVER STYLUS GESTURE FUNCTIONALITY

(71) Applicant: BARNESANDNOBLE.COM LLC, New York, NY (US)

(72) Inventors: Kourtny M. Hicks, Sunnyvale, CA (US); Amir Mesguich Havilio, Palo Alto, CA (US)

(73) Assignee: barnesandnoble.com llc, New York, NY (US)

(21) Appl. No.: 13/793,426

(22) Filed: Mar. 11, 2013

Related U.S. Application Data
(63) Continuation-in-part of application No. 13/757,378, filed on Feb. 1, 2013.

(51) Int. Cl. G06F 3/033

(52) U.S. Cl. CPC G06F 3/033
USPC 345/179

(57) ABSTRACT

Techniques are disclosed for performing functions in electronic devices using stylus gestures while the stylus is hovering over a stylus detection surface of an electronic device. In some cases, a stylus gesture may be accompanied with the user holding down one or more stylus control features. Each uniquely identifiable gesture or combination of gestures may be associated with a distinct device or stylus function. The device may detect whether the stylus is pointing to specific content on the device at the beginning of a gesture and the stylus hover over gesture may perform functions on selected content or on one or more UI control features or icons on the device. In other cases, functions can be performed without reference to specific content. The device may track stylus location, and the non-touch stylus gestures may be location sensitive. An animation can be displayed as non-touch stylus gestures are executed.

### RELATED APPLICATION

This application is a continuation-in-part to U.S. application Ser. No. 13/757,378 filed Feb. 1, 2013 which is herein incorporated by reference in its entirety.

### FIELD OF THE DISCLOSURE

This disclosure relates to electronic display devices, and more particularly, to user interface techniques for interacting with stylus sensitive computing devices.

### BACKGROUND

Electronic display devices such as tablets, eReaders, mobile phones, smart phones, personal digital assistants (PDAs), and other such stylus sensitive electronic display devices are commonly used for displaying consumable content. The content may be, for example, an eBook, an online article or blog, images, documents, a movie or video, just to name a few types. Such display devices are also useful for displaying a user interface that allows a user to interact with files or other content on the device. The user interface may include, for example, one or more screen controls and/or one or more displayed labels that correspond to nearby hardware buttons. The user may interact with the touch/stylus sensitive device using fingers, a stylus, or other implement. The display may be backlit or not, and may be implemented for instance with an LCD screen or an electrophoretic display. Such devices may also include other contact sensitive surfaces, such as a track pad (e.g., capacitive or resistive sensor) or contact sensitive housing (e.g., acoustic sensor).

### BRIEF DESCRIPTION OF THE DRAWINGS

FIGS. 1a-b illustrate an example electronic computing device with a stylus detection surface configured to detect stylus hover over gestures, in accordance with an embodiment of the present invention.

FIG. 1c illustrates an example stylus for use with an electronic computing device, configured in accordance with an embodiment of the present invention.

FIGS. 1d-e illustrate example configuration screen shots of the user interface of the electronic device shown in FIGS. 1a-b, configured in accordance with an embodiment of the present invention.

FIG. 2a illustrates a block diagram of an electronic computing device with a stylus sensitive display, configured in accordance with an embodiment of the present invention.

FIG. 2b illustrates a block diagram of a stylus configured in accordance with an embodiment of the present invention.

FIG. 2c illustrates a block diagram of a communication link between the electronic computing device of FIG. 2a and the stylus of FIG. 2b, configured in accordance with an embodiment of the present invention.

FIGS. 3a-b illustrate an example of an electronic stylus sensitive device and stylus wherein a stylus hover over action adjusts screen brightness, in accordance with an embodiment of the present invention.

FIGS. 4a-b illustrate an example of an electronic stylus sensitive device and stylus wherein a stylus hover over action opens a tools menu, in accordance with an embodiment of the present invention.

FIGS. 5a-b illustrate an example of an electronic stylus sensitive device and stylus configured to perform stylus hover over actions, in accordance with an embodiment of the present invention.

FIG. 6 illustrates an example of an electronic stylus sensitive device and stylus wherein the stylus hover over gesture mode may be configured within an application, in accordance with an embodiment of the present invention.

FIG. 7 illustrates a method for performing device functions using a stylus hover over gesture, in accordance with an embodiment of the present invention.

### DETAILED DESCRIPTION

Techniques are disclosed for performing functions in electronic devices using stylus gestures while the stylus is hovering over or otherwise sufficiently proximate to a stylus detection surface. The stylus hover over gestures may be configured to perform various configurable and/or hard-coded functions. The stylus detection surface may be, for example, incorporated into a stylus sensitive display, or may be a separate stylus detection surface associated with the display of the electronic computing device. A stylus hover over gesture may include performing a specific gesture or motion with the stylus tip above the detection surface without making direct contact with that surface. In some cases, a stylus gesture may be accompanied with the user holding down one or more stylus control features. Each uniquely identifiable gesture or combination of gestures may be associated with a distinct device or stylus function. In some cases, the stylus detection surface may detect whether the stylus is pointing to specific content on the device at the beginning of a gesture and the stylus hover over gesture may perform functions on selected content or on one or more UI control features or icons on the device. In other cases, no specific content selection is needed; rather, the function performed is selection-free. In some embodiments, the device may track the stylus location over the stylus detection surface and the stylus hover over gesture may be location sensitive. In such an example, a stylus hover over gesture may perform different functions depending on the stylus' location above the stylus detection surface. The various functions assigned to hover over stylus gestures may be performed on a content specific level, an application specific level, or a global device level. An animation can be displayed as the stylus hover over gestures perform various functions on the device.

General Overview

As previously explained, electronic display devices such as tablets, eReaders, and smart phones are commonly used for displaying user interfaces and consumable content. In typical operation, the user might desire to, for example, adjust volume or brightness, open a file, open up a tools menu, change screen settings, switch application, perform the undo, copy, paste, or delete functions, or otherwise interact with a given electronic device. While most electronic devices typically provide a series of direct contact actions for performing these various tasks, there does not appear to be an intuitive hover over stylus gesture based user interface function for performing such tasks.

Thus, and in accordance with an embodiment of the present invention, stylus-based techniques are provided for performing functions in electronic devices using stylus gestures while the stylus is hovering over a stylus detection surface (e.g., within a few centimeters or the surface, or otherwise sufficiently close such that the stylus-based gesture can be detected by the stylus detection surface). The techniques disclosed may be used to perform functions at an electronic device by performing stylus gestures without requiring direct contact between the stylus and the electronic device. A stylus hover over gesture, such as a clockwise circular gesture, may be associated with a function such as increasing volume, increasing brightness, increasing font size, bringing up a tools menu, creating a note (e.g. such as notes taken during an educational lecture, or a message for another user of the device, or a reminder, etc), undo, recording a lecture or other ambient sounds, etc. In a more general sense, any uniquely identifiable stylus gesture or combination of gestures performed while hovering over a stylus detection surface may be configured to perform a stylus or device function. In some embodiments, the stylus may be pointing to a specific selection of content, a UI control feature or icon, or a specific area of a stylus sensitive display. In such an example, the stylus hover over gesture may be used to perform an operation on the selected content, open the selected file or application, manipulate the UI control feature, etc. In one specific such example, a stylus hover over gesture may be associated with a different function depending on the area of the screen over which the stylus is hovering. In other embodiments, the stylus hover over gesture may be configured to perform a certain function regardless of whether content is selected or where the stylus is pointing. In some such selection-free embodiments, the stylus hover over gesture may perform a certain function based on a currently running application, or a specific stylus gesture may be globally associated with a specific device function. Numerous selection-free hover over stylus gestures will be apparent in light of this disclosure, and such functions may be user-configurable or hard-coded.

In some embodiments, the hover over stylus gesture may be combined with or otherwise preceded by a content selection action (e.g., a single item selection, a select-and-drag action, a book-end selection where content between two end points is selected, or any other available content selection technique). As will be appreciated, the stylus may be used to make the content selection, but it need not be; rather, content may be selected using any means. In one example embodiment, the user may select a section of text, and then perform the copy function (or other function assigned to a stylus gesture), which will save the selected text onto the stylus. In a more general sense, the stylus may be used to perform functions on content that was preselected with or without the stylus, or to simultaneously select and perform functions on target content. The degree to which the selection and other functions overlap may vary depending on factors such as the type of content and the processing capability of the stylus and/or related device.

In some example embodiments, the hover over stylus gestures are accompanied with animation, sound and/or haptic effects to further enhance the user interface experience. For example, copy animation might show a vortex or sucking of the selected content into the stylus if the stylus hover over gesture is being used to copy content into the stylus or other target location. In a similar fashion, a volume increase animation might show a speaker with an increasing number of sound waves coming from it if the stylus hover over gesture is being used to increase volume. If a selection-free no-contact undo stylus gesture is being executed, then a sound could accompany the undo function, such as a custom sound selected by the user, or any other suitable sound. A combination of animation, sound, haptic, and/or other suitable notifications can be used as well, as will be appreciated in light of this disclosure.

The techniques have a number of advantages, as will be appreciated in light of this disclosure. For instance, in some cases, the techniques can be employed to provide a discreet and intuitive way for a user to interact with a device without overly distracting the user (or others nearby) from other events occurring during the interaction. For instance, in some such embodiments, a student attending a lecture (either live or via a network) can activate note taking and voice recording applications via non-touch stylus-based control actions, without having to look at the device (or with minimal looking). In such cases, for instance, the student can hold the stylus generally over the stylus sensitive surface while still maintaining focus and concentration on the lecturer and presentation materials, and readily activate tools that can supplement the educational experience.

Numerous uniquely identifiable engagement and notification schemes that exploit a stylus and a stylus detection surface to effect desired functions without requiring direct contact on the touch sensitive surface can be used, as will be appreciated in light of this disclosure. Further note that any stylus detection surface (e.g., track pad, touch screen, electro-magnetic resonance (EMR) sensor grid, or other stylus sensitive surface, whether capacitive, resistive, acoustic, or other stylus detecting technology) may be used to detect the stylus hover over action and the claimed invention is not intended to be limited to any particular type of stylus detection technology, unless expressly stated.

Architecture

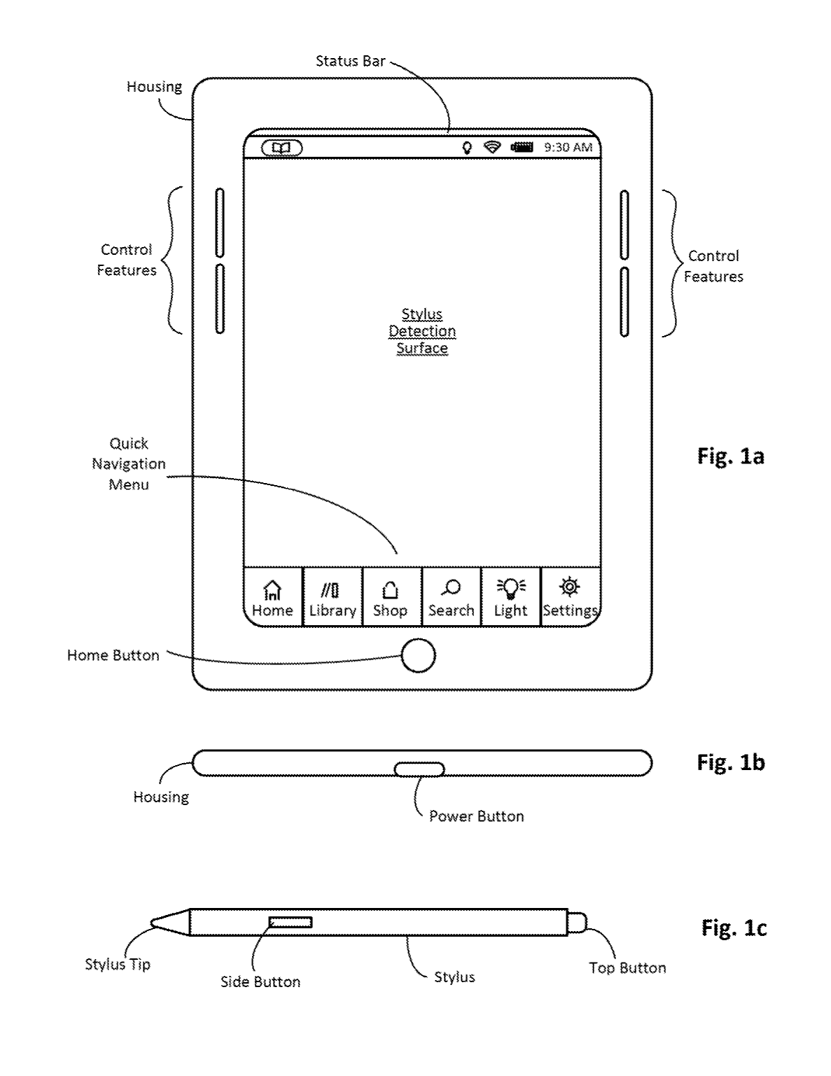

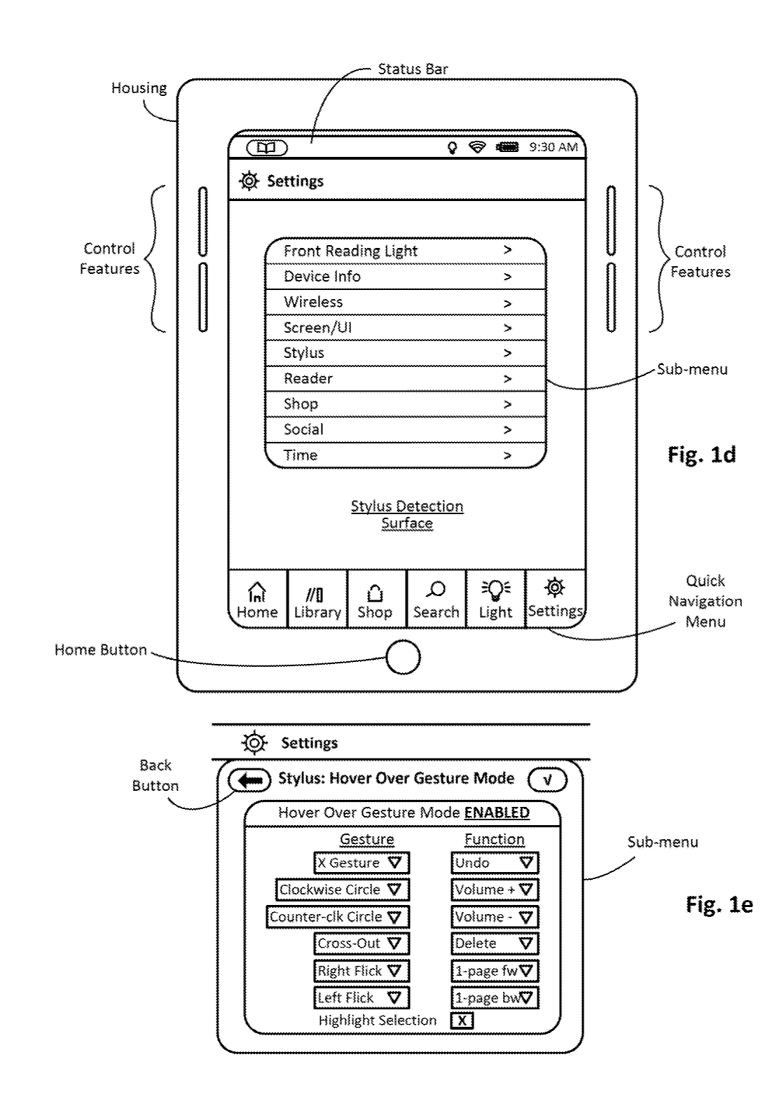

FIGS. 1a-b illustrate an example electronic computing device with a stylus detection surface configured to detect stylus hover over actions, in accordance with an embodiment of the present invention. As can be seen, in this example embodiment, the stylus detection surface is a touch screen surface. The device could be, for example, a tablet such as the NOOK® tablet or eReader by Barnes & Noble. In a more general sense, the device may be any electronic device having a stylus detection user interface and capability for displaying content to a user, such as a mobile phone or mobile computing device such as a laptop, a desktop computing system, a television, a smart display screen, or any other device having a stylus detection display or a non-sensitive display screen that can be used in conjunction with a stylus detection surface. In a more general sense, the touch sensitive device may comprise any touch sensitive device with built-in componentry to accept/recognize input from a stylus with which the device can be paired so as to allow for stylus input, including stylus hover over functionality as described herein. As will be appreciated, the claimed invention is not intended to be limited to any particular kind or type of electronic device.

As can be seen with this example configuration, the device comprises a housing that includes a number of hardware features such as a power button, control features, and a press-button (sometimes called a home button herein). A user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such user interface (UI) features, or different UI features altogether, depending on the target application of the device. Any such general UI controls and features can be implemented using any suitable conventional or custom technology, as will be appreciated.

The hardware control features provided on the device housing in this example embodiment are configured as elongated press-bars and can be used, for example, to page forward (using the top press-bar) or to page backward (using the bottom press-bar), such as might be useful in an eReader application. The power button can be used to turn the device on and off, and may be used in conjunction with a touch-based UI control feature that allows the user to confirm a given power transition action request (e.g., such as a slide bar or tap point graphic to turn power off). Numerous variations will be apparent, and the claimed invention is not intended to be limited to any particular set of hardware buttons or features, or device form factor.

In this example configuration, the home button is a physical press-button that can be used as follows: when the device is awake and in use, tapping the button will display the quick navigation menu, which is a toolbar that provides quick access to various features of the device. The home button may also be configured to cease an active function that is currently executing on the device, or close a configuration sub-menu that is currently open. The button may further control other functionality if, for example, the user presses and holds the home button. For instance, an example such push-and-hold function could engage a power conservation routine where the device is put to sleep or an otherwise lower power consumption mode. So, a user could grab the device by the button, press and keep holding as the device is stowed into a bag or purse. Thus, one physical gesture may safely put the device to sleep. In such an example embodiment, the home button may be associated with and control different and unrelated actions: 1) show the quick navigation menu; 2) exit a configuration sub-menu; and 3) put the device to sleep. As can be further seen, the status bar may also include a book icon (upper left corner). In some cases, selecting the book icon may provide bibliographic information on the content or provide the main menu or table of contents for the book, movie, playlist, or other content.

FIG. 1c illustrates an example stylus for use with an electronic computing device configured in accordance with an embodiment of the present invention. As can be seen, in this particular configuration, the stylus comprises a stylus tip used to interact with the stylus detection surface (by either direct contact or hover over interaction, or otherwise sufficiently proximate indirect contact) and control features including a top button and a side button along the shaft of the stylus. In this example, the stylus tip has a rounded triangular shape, while in alternative embodiments the stylus tip may be more rounded, or any other suitable shape. The stylus tip may be made of any number of materials of different textures and firmness depending on the needs of the specific device. The stylus may include fewer or additional control features than the top and side buttons illustrated in FIG. 1c, or different control features altogether. Such control features may include, for example, a rotating knob, a switch, a touch-sensitive area, a pressure-sensitive area, a sliding control switch, and/or other suitable control features as will be apparent in light of this disclosure. The principles disclosed herein equally apply to such control features. For ease of description, stylus examples are provided with push button control features. The stylus may be an active or passive stylus, or any other suitable implement for interacting with the device and performing hover over gestures. As will be appreciated, the claimed invention is not intended to be limited to any particular kind or type of stylus.

In one particular embodiment, a stylus hover over gesture configuration sub-menu, such as the one shown in FIG. 1e, may be accessed by selecting the Settings option in the quick navigation menu, which causes the device to display the general sub-menu shown in FIG. 1d. From this general sub-menu, the user can select any one of a number of options, including one designated Stylus in this specific example case. Selecting this sub-menu item may cause the configuration sub-menu of FIG. 1e to be displayed, in accordance with an embodiment. In other example embodiments, selecting the Stylus option may present the user with a number of additional sub-options, one of which may include a so-called “stylus hover over gesture” option, which may then be selected by the user so as to cause the stylus hover over gesture configuration sub-menu of FIG. 1e to be displayed. Any number of such menu schemes and nested hierarchies can be used, as will be appreciated in light of this disclosure. In other embodiments, the stylus hover over gesture function is hard-coded such that no configuration sub-menus are needed or otherwise provided (e.g., clockwise rotation of stylus tip while hovering over the device for carrying out actions as described herein, with no user configuration needed). The degree of hard-coding versus user-configurability can vary from one embodiment to the next, and the claimed invention is not intended to be limited to any particular configuration scheme of any kind, as will be appreciated.

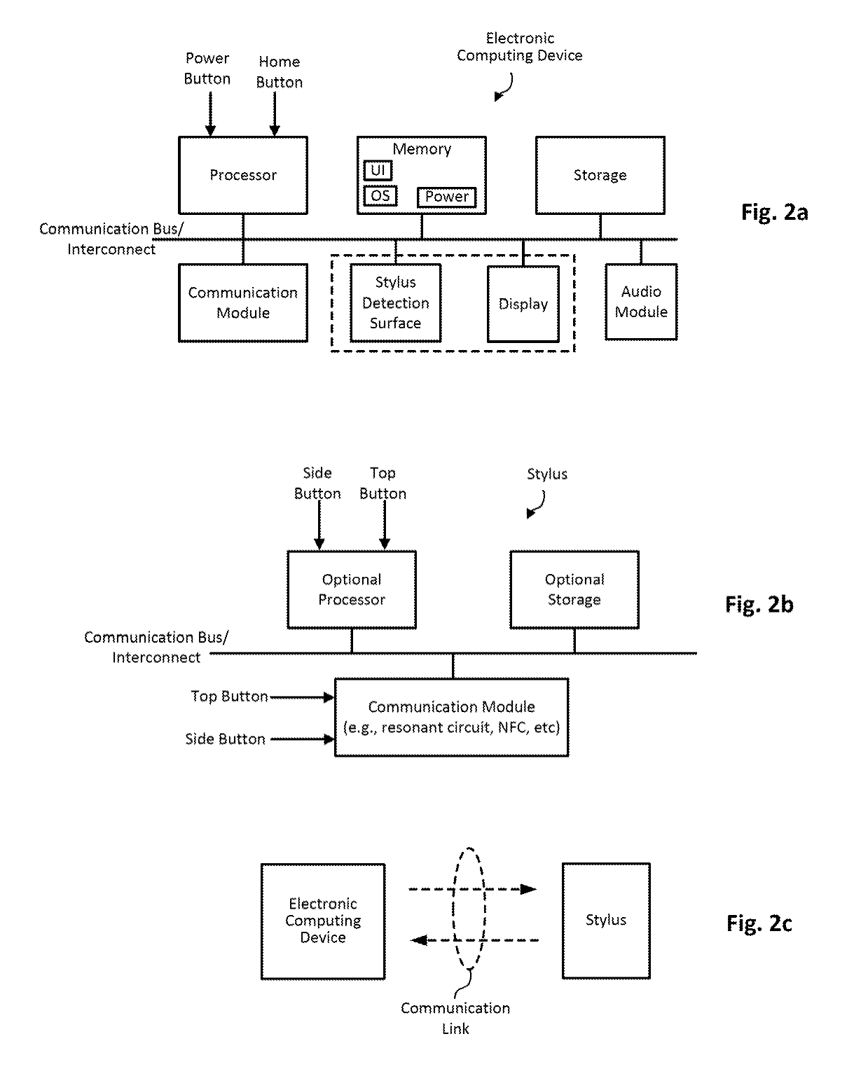

As will be appreciated, the various UI control features and sub-menus displayed to the user are implemented as UI hover over stylus controls in this example embodiment. Such UI screen controls can be programmed or otherwise configured using any number of conventional or custom technologies. In general, the stylus detection display translates a specific hover over stylus gesture in a given location into an electrical signal which is then received and processed by the device's underlying operating system (OS) and circuitry (processor, etc.). Additional example details of the underlying OS and circuitry in accordance with some embodiments will be discussed in turn with reference to FIG. 2a.

The stylus detection surface (or stylus detection display, in this example case) can be any surface that is configured with stylus detecting technologies capable of non-contact detection, whether capacitive, resistive, acoustic, active-stylus, and/or other input detecting technology. The screen display can be layered above input sensors, such as a capacitive sensor grid for passive touch-based input, such as with a finger or passive stylus in the case of a so-called in-plane switching (IPS) panel, or an electro-magnetic resonance (EMR) sensor grid. In some embodiments, the stylus detection display can be configured with a purely capacitive sensor, while in other embodiments the touch screen display may be configured to provide a hybrid mode that allows for both capacitive input and EMR input, for example. In still other embodiments, the stylus detection surface is configured with only an active stylus sensor. Numerous touch screen display configurations can be implemented using any number of known or proprietary screen based input detecting technologies. In any such embodiments, a stylus detection surface controller may be configured to selectively scan the stylus detection surface and/or selectively report stylus inputs detected proximate to (e.g., within a few centimeters, or otherwise sufficiently close so as to allow detection) the stylus detection surface.

In one example embodiment, a stylus input can be provided by the stylus hovering some distance above the stylus detection display (e.g., one to a few centimeters above the surface, or even farther, depending on the sensing technology deployed in the stylus detection surface), but nonetheless triggering a response at the device just as if direct contact were provided directly on the display. As will be appreciated in light of this disclosure, a stylus as used herein may be implemented with any number of stylus technologies, such as a DuoSense® pen by N-trig® (e.g., wherein the stylus utilizes a touch sensor grid of a touch screen display) or EMR-based pens by Wacom technology, or any other commercially available or proprietary stylus technology. Further recall that the stylus sensor in the computing device may be distinct from an also provisioned touch sensor grid in the computing device. Having the touch sensor grid separate from the stylus sensor grid allows the device to, for example, only scan for an stylus input, a touch contact, or to scan specific areas for specific input sources, in accordance with some embodiments. In one such embodiment, the stylus sensor grid includes a network of antenna coils that create a magnetic field which powers a resonant circuit within the stylus. In such an example, the stylus may be powered by energy from the antenna coils in the device and the stylus may return the magnetic signal back to the device, thus communicating the stylus' location above the device, angle of inclination, speed of movement, and control feature activation (e.g., push-button action). Such an embodiment also eliminates the need for a battery on the stylus because the stylus can be powered by the antenna coils of the device. In one particular example, the stylus sensor grid includes more than one set of antenna coils. In such an example embodiment, one set of antenna coils may be used to merely detect the presence of a hovering or otherwise sufficiently proximate stylus, while another set of coils determines with more precision the stylus' location above the device and can track the stylus' movements.

As previously explained, and with further reference to FIGS. 1d and 1e, once the Settings sub-menu is displayed (FIG. 1d), the user can then select the Stylus option. In response to such a selection, the stylus hover over gesture configuration sub-menu shown in FIG. 1e can be provided to the user. The user can configure a number of functions with respect to the stylus hover over gesture function, in this example embodiment. For instance, in this example case, the configuration sub-menu includes a UI check box that when checked or otherwise selected by the user, effectively enables the stylus hover over gesture mode (shown in the enabled state); unchecking the box disables the mode. Other embodiments may have the stylus hover over gesture mode always enabled, or enabled by a physical switch or button located on either the device or the stylus, for example. In addition, once the hover over action mode is enabled, the user can associate a function with various gestures using a drop down menu, as will be explained in turn. Examples of possible functions include, select content/icon, run application, cut, copy, delete, undo, redo, next page, zoom in/out, adjust font size, adjust brightness, adjust volume, open a tools menu, switch tool or application, skip scene, create a note (on device), or start an audio or video recording of a classroom lecture or other event (from device or stylus if stylus is configured to record/store sounds/video). Hover over gesture functions may be configured, for example, on a content specific level, an application specific level, or on a global level wherein the gesture performs the same function regardless of the application running or type of content currently displayed at the time, and regardless of whether content is selected.

With further reference to the example embodiment of FIG. 1e, the user may associate a number of stylus hover over gestures with unique functions. In one example embodiment, such gestures and functions may be configured by the user using various gesture pull-down menus and corresponding function pull-down menus. In this particular example, the X-shaped gesture is associated with the undo function, a clockwise circular gesture is associated with the increasing volume function, a counter-clockwise circular gesture is associated with the decreasing volume function, a cross-out gesture is associated with the delete function, a right flick is associated with the page forward function (1-page per flick), and a left flick is associated with the page backward function (1-page per flick). The cross-out gesture may include, for example, a horizontal back and forth motion of the stylus tip along a single line (or comparably so), like crossing something out, and may include two or more at least partially overlapping stylus strokes. A flick gesture may include, for example, any accelerated stylus gesture, whether it be forward, backward, left, right, or some other direction in the x-y plane. In some such x-y flick gestures, one end of the stylus is accelerated in a given direction and the other end of the stylus acts as a relatively fixed pivot point. In still other embodiments, a flick gesture may generally include twisting or tilting the stylus in a given direction, such that the ends of the stylus move in opposite directions. Such a flick can be carried out, for instance, by a flick or twist of the user's wrist/arm. In other embodiments, a flick gesture may include accelerating the stylus tip directly toward or away from the stylus detection surface in the z plane. Many other stylus hover over gestures may be associated with various stylus or device functions. Additional example stylus hover over gestures include swipe gestures, an S-shaped gesture, alpha-numeric shaped gestures (for use in a note-taking program, for example), or any other uniquely identifiable stylus hover over motion. As used herein, a stylus swipe may include a sweeping stylus gesture across at least a portion of the stylus detection surface in a given direction. In some embodiments, the sweeping gesture may be performed at a constant speed in one direction. In one embodiment, the gestures are performed with the stylus tip, while in other embodiments the other end of the stylus may be used, or any other suitable part of a stylus or other implement. In addition, the stylus of this example case includes a top button and a side button, and once the hover over action mode is enabled, the user may be able to associate a function with gestures accompanied by each of the buttons. In such an example, a clockwise circular gesture with the top button pressed may be configured to increase volume, while a clockwise circular gesture only (with no button press) may be configured to increase screen brightness. Further note that the gesture may include a virtual hold point, where the stylus effectively “stares” at a given point on the stylus detection surface, wherein such staring may be detected after a certain time period elapses (e.g., 2 seconds or more). For instance, a stare gesture may be used for selecting a user interface control feature or icon or content on the device. In some cases, a stare gesture may be used in combination with another gesture. For example, a stare-flick combination can be used to increment or decrement a device parameter such as volume or display brightness, or to bring up a tools menu. In one such case, for instance, a 2-second stare at volumne or brightness UI control feature of the device followed by an upward flick can cause an increase in volume or display brightness, while a 2-second stare at that UI control feature followed by a downward flick can cause a decrease in volume or display brightness. Similarly, 2-second stare at a UI tools icon of the device followed by a right-flick can cause the tools menu to display, and a 1-second stare at an option on that displayed UI tools icon of the device followed by a left-flick can cause particular tools to be launched. Numerous such combinations can be used, as will be appreciated in light of this disclosure.

In some embodiments the user may also enable a highlight selection option, which may highlight content when the stylus is pointing toward that content while hovering over the stylus detection surface. In other embodiments, targeted or preselected content may be highlighted in order to notify the user that certain content will be affected by the stylus hover over gesture. In the particular embodiment shown in FIG. 1e, the highlight mode is enabled and the application, document, selection of text, etc. upon which the stylus hover over gesture will be performed is highlighted. As used here, highlighting may refer, for example, to any visual and/or aural indication of a content selection, which may or may not include a formatting change. In one particular embodiment, the stylus hover over gesture may be associated with deleting content and the highlighting function may outline a particular section of text that the stylus is pointing toward, thus indicating that a certain stylus gesture at that moment will delete that section of text.

In other embodiments, the hover over gesture mode can be invoked whenever the stylus is activated, regardless of the application being used. Any number of applications or device functions may benefit from a stylus hover over gesture mode as provided herein, whether user-configurable or not, and the claimed invention is not intended to be limited to any particular application or set of applications.

As can be further seen, a back button arrow UI control feature may be provisioned on the screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Numerous other configurable aspects will be apparent in light of this disclosure. For instance, in some embodiments, the stylus hover over gesture function can be assigned on a context basis. For instance, the configuration menu may allow the user to assign one gesture to copy entire files or emails and assign another gesture to copy within a given file. Thus, the techniques provided herein can be implemented on a global level, a content based level, or an application level, in some example cases. Note that in some embodiments the various stylus gestures may be visually demonstrated to the user as they are carried out via copy, delete, or other suitable function animations. Such animations provide clarity to the function being performed, and in some embodiments the animations may be user-configurable while they may be hard-coded in other embodiments.

The configuration sub-menu shown in FIG. 1e is presented merely as an example of how a stylus hover over gesture mode may be configured by the user. In other user-configurable embodiments, the user may be able to access a configuration sub-menu that allows the user to specify certain applications in which the stylus hover over gesture mode can be invoked. Such a configuration feature may be helpful, for instance, in a tablet or laptop or other multifunction computing device that can execute different applications (as opposed to a device that is more or less dedicated to a particular application). In one such example case, the available applications may be provided along with a corresponding pull-down menu, or with a UI check box or some other suitable UI feature. Example applications in which a stylus hover over gesture mode may be enabled or configured include an eBook application, a photo viewing application, a browser application, a file manager application, a tools menu, and a video player, just to name a few examples. In some cases the user may be able to customize gestures and functions within each application, if desired.

FIG. 2a illustrates a block diagram of an electronic computing device with a stylus sensitive display, configured in accordance with an embodiment of the present invention. As can be seen, this example device includes a processor, memory (e.g., RAM and/or ROM for processor workspace and storage), additional storage/memory (e.g., for content), a communications module, a display, a stylus detection surface, and an audio module. A communications bus and interconnect is also provided to allow inter-device communication. Other typical componentry and functionality not reflected in the block diagram will be apparent (e.g., battery, co-processor, etc.). Further note that in some embodiments the stylus detection surface may be integrated into the device display. Alternatively, the stylus detection surface may include a track pad, a housing configured with one or more acoustic sensors, a separate stylus sensitive surface that may be connected to the device via cables or a wireless link, etc. As discussed above, the stylus detection surface may employ any suitable input detection technology that is capable of translating a stylus gesture performed while hovering over the surface into an electronic signal that can be manipulated or otherwise used to trigger a specific user interface action, such as those provided herein. The principles provided herein equally apply to any such stylus sensitive devices. For ease of description, examples are provided with stylus sensitive displays.

In this example embodiment, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc), and encoded on a machine readable medium, that when executed by the processor (and/or co-processors), carries out the functionality of the device including a UI having a hover over stylus gesture function as described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g. inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., 800 MHz Texas Instruments OMAP3621 applications processor), and may include one or more co-processors or controllers to assist in device control. In this example case, the processor receives input from the user, including input from or otherwise derived from the power button and the home button. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 6-inch E-ink Pearl 800×600 pixel screen with NeonodeK zForce8 touch screen, or any other suitable display and touch screen interface technology. The communications module can be configured to execute, for instance, any suitable protocol which allows for connection to the stylus so that hover over stylus gestures may be detected by the device, or to otherwise provide a communication link between the device and the stylus or other external systems. Note in some cases that slider actions of the stylus are communicated to the device by virtue of the stylus detection surface and not the communication module. In this sense, the communication module may be optional. Example communications modules may include an NFC (near field connection), Bluetooth, 802.11b/g/n WLAN, or other suitable chip or chip set that allows for wireless connection to the stylus (including any custom or proprietary protocols). In some embodiments, a wired connection can be used between the stylus and device. In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc). The device may be smaller, for example, for smartphone and tablet applications and larger for smart computer monitor applications.

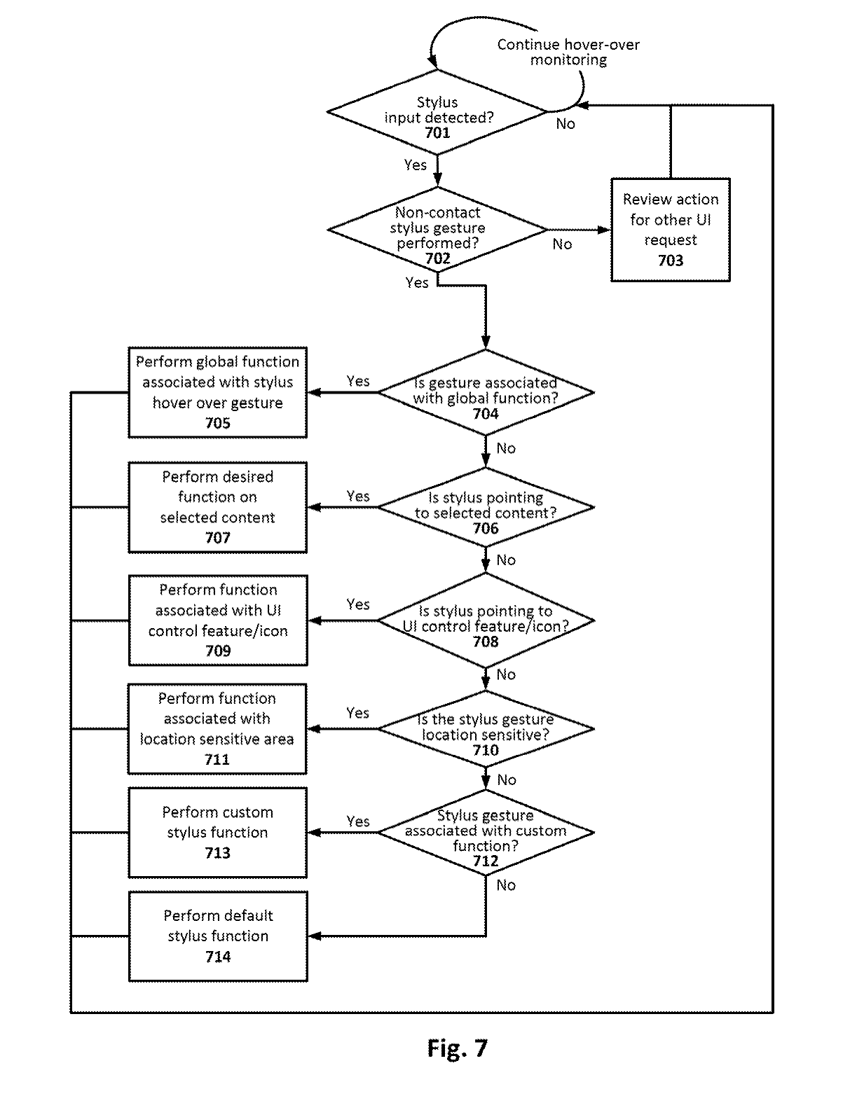

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured, for example, to automatically transition the device to a low power consumption or sleep mode after a period of non-use. A wake-up from that sleep mode can be achieved, for example, by a physical button press and/or a stylus hover over gesture, a touch screen swipe or other action. The user interface (UI) module can be programmed or otherwise configured, for example, to carryout user interface functionality, including that functionality based on stylus hover over detection as discussed herein and the various example screen shots shown in FIGS. 1a, 1d-e, 3a-b, 4a-b, 5a-b, and 6 in conjunction with the stylus hover over gesture methodologies demonstrated in FIG. 7, which will be discussed in turn. The audio module can be configured, fbr example, to speak or otherwise aurally present a selected eBook table of contents or other textual content, if preferred by the user. Numerous commercially available text-to-speech modules can be used, such as Verbose text-to-speech software by NCH Software. In some example cases, if additional space is desired, for example, to store digital books or other content and media, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

FIG. 2b illustrates a block diagram of a stylus configured in accordance with an embodiment of the present invention. As can be seen, this example stylus includes a storage/memory and a communication module. A communications bus and interconnect may be provided to allow inter-device communication. An optional processor may also be included in the stylus to provide local intelligence, but such is not necessary in embodiments where the electronic computing device with which the stylus is conununicatively coupled provides the requisite control and direction. Other componentry and functionality not reflected in the block diagram will be apparent (e.g., battery, speaker, antenna, etc). The optional processor can be any suitable processor and may be programmed or otherwise configured to assist in controlling the stylus, and may receive input from the user from control features including a top and side button. The storage may be implemented with any suitable memory and size (e.g., 2 to 4 GBytes of flash memory). In other example embodiments, storage/memory on the stylus itself may not be necessary.

The communications module can be, for instance, any suitable module which allows for connection to a nearby electronic device so that information may be passed between the device and the stylus. Example communication modules may include an NFC, Bluetooth, 802.11b/g/n WLAN, or other suitable chip or chip set which allows for connection to the electronic device.

In other embodiments, the communication module of the stylus may implement EMR or other similar technologies that can communicate stylus information to a device, including stylus location and whether a stylus gesture has been performed, without a separate communications chip or chip set. In one such example, the stylus may include a communication module comprising a resonator circuit that may be manipulated using the various control features of the stylus. In such an example, performing hover over gestures with the stylus may be accomplished by using a control feature to adjust the resonant frequency of the resonator circuit. The altered resonant frequency may be detected, for example, by an EMR detection grid of the stylus detection surface of the device, thus triggering a response at the device. Note in such a case that a separate dedicated communication module on the electronic computing device may be optional.

In another example case, the communications module may receive input from the user in the form of stylus hover over gestures, wherein such inputs can be used to enable the various functions of the communications module. As will be appreciated, commands may be communicated and/or target content may be transferred between (e.g., copied or cut or pasted) the stylus and the electronic device over a communication link. In one embodiment, the stylus includes memory storage and a transceiver, but no dedicated processor. In such an embodiment, the processor of the electronic device communicates with the transceiver of the stylus and performs the various functions as indicated by the user.

FIG. 2c illustrates a block diagram showing a communication link between the electronic computing device of FIG. 2a and the stylus of FIG. 2b, according to one embodiment of the present invention. As can be seen, the system generally includes an electronic computing device that is capable of wirelessly connecting to other devices and a stylus that is also capable of wirelessly connecting to other devices. In this example embodiment, the electronic computing device may be, for example, an e-Book reader, a mobile cell phone, a laptop, a tablet, desktop, or any other stylus sensitive computing device. As described above, the communication link may include an NFC, Bluetooth, 802.11b/g/n WLAN, electro-magnetic resonance, or other suitable communication link which allows for communication between one or more electronic devices and a stylus. In some embodiments EMR technology may be implemented along with one or more of NFC. Bluetooth, 802.11b/g/n WLAN, etc. In one such example, EMR may be used to power a stylus and track its location above a device while NFC may enable data transfer between the stylus and the device. In some embodiments, the stylus may be configured in real-time over the communication link. In one such example, the user may adjust stylus configuration settings using the various menus and sub-menus such as those described in FIGS. 1d-e and the stylus may be reconfigured in real-time over the communication link.

In some embodiments the function may be performed regardless of where the stylus is located above the stylus sensitive display, however, the stylus gestures may be location sensitive. In one specific example, a clockwise gesture above one area of the screen (the bottom right area, for example) may result in an increase in the font size while a clockwise gesture above another area of the screen (the bottom left, for example) may result in an increase in volume. As discussed above, such functions may be hard-coded or user-configurable.

Example Stylus Hover Over Gesture Functions

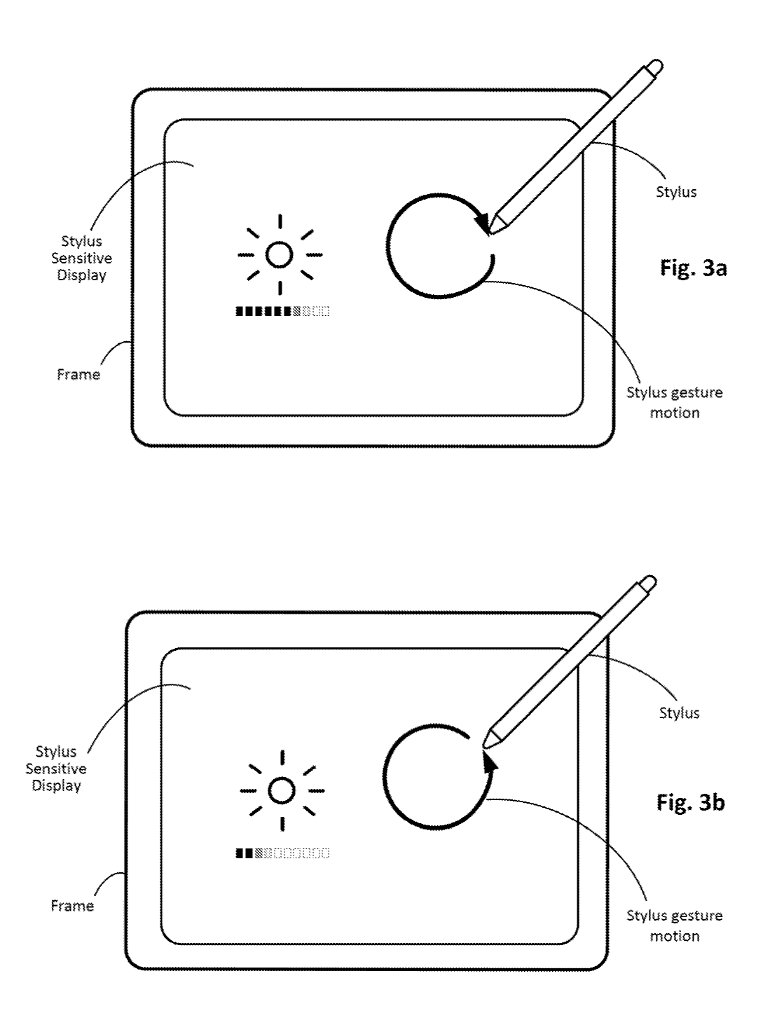

FIGS. 3a-b illustrate an example of an electronic stylus sensitive device and stylus wherein a stylus hover over gesture adjusts screen brightness, in accordance with an embodiment of the present invention. As can be seen, a physical frame or support structure is provided about the stylus sensitive display. In this particular example scenario, the clockwise stylus hover over gesture is associated with increasing screen brightness (e.g., hard-coded or via a configuration sub-menu) and the user is performing the clockwise circular gesture. In this example case, the hover over action mode is enabled (e.g., as described in reference to FIG. 1e, or hard-coded) and the user has pointed the stylus toward the stylus sensitive display. The function of increasing screen brightness in this example case is accompanied by a graphic showing an increasing value bar beneath a brightness icon, thus showing the user that screen brightness is increasing as the clockwise circular gesture is performed. In some embodiments the screen brightness (or other function associated with a stylus gesture) may increase more rapidly if the circular gesture is performed quickly by the user.

In the example shown in FIG. 3b, when the user performs the counter-clockwise circular stylus hover over gesture, the screen brightness decreases, as shown. In this example case, the hover over action mode is enabled and the function of decreasing screen brightness is accompanied by a graphic showing a decreasing value bar beneath a brightness icon. In other embodiments the function may be accompanied by sounds, or a combination of graphics and sounds. As previously explained, the resulting action may be user-configurable or hard-coded and the rate of the function may be associated with the speed with which the user performs the stylus gesture.

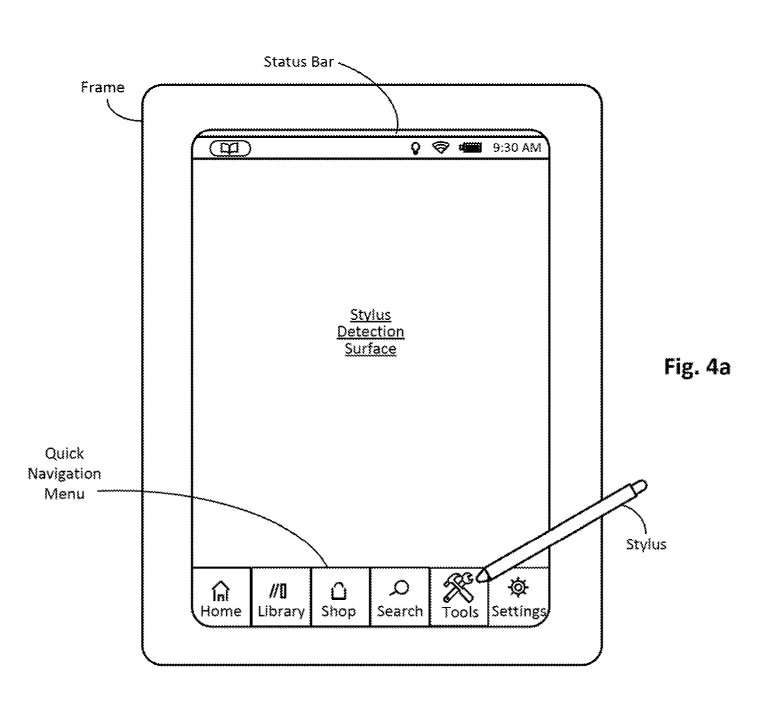

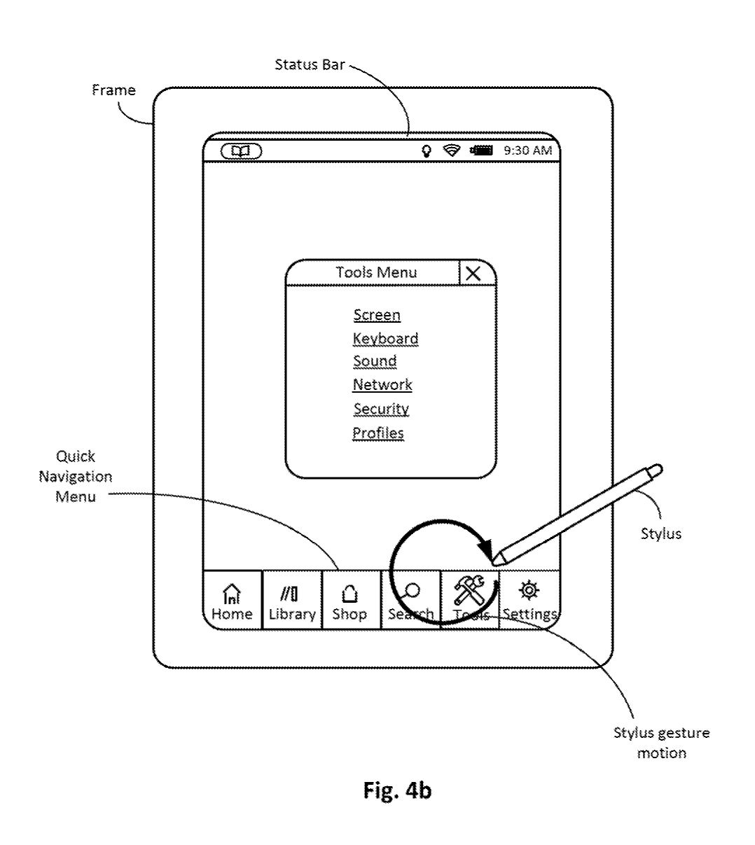

FIGS. 4a-b illustrate an example of an electronic stylus sensitive device and stylus wherein a stylus hover over gesture opens a tools menu, in accordance with an embodiment of the present invention. As can be seen, a physical frame or support structure is provided about the stylus sensitive display. In this example, a stylus sensitive display screen is displaying an initial menu screen with a status bar and a quick navigation menu at the bottom of the screen. In the example shown in FIG. 4a, the quick navigation menu includes a tools icon, and the clockwise circular stylus hover over gesture is associated with opening a file or menu item (e.g., hard-coded or via a configuration sub-menu). In this example, the stylus is pointing toward the tools icon in the quick navigation menu. In another embodiment, the tools icon may be highlighted when the stylus is pointed toward it, thus notifying the user that a stylus gesture at that moment will perform some function associated with the stylus icon.

In the example shown in FIG. 4b, the user has performed the clockwise circular stylus gesture while the stylus is hovering over, or otherwise sufficiently proximate to, the surface of the device and oriented toward the tools icon. As can be seen, when the circular stylus gesture is performed, the tools menu is opened and displayed to the user. In some embodiments the function may be accompanied by sounds, or a combination of graphics and sounds. As previously explained, the various stylus actions may be user-configurable or hard-coded.

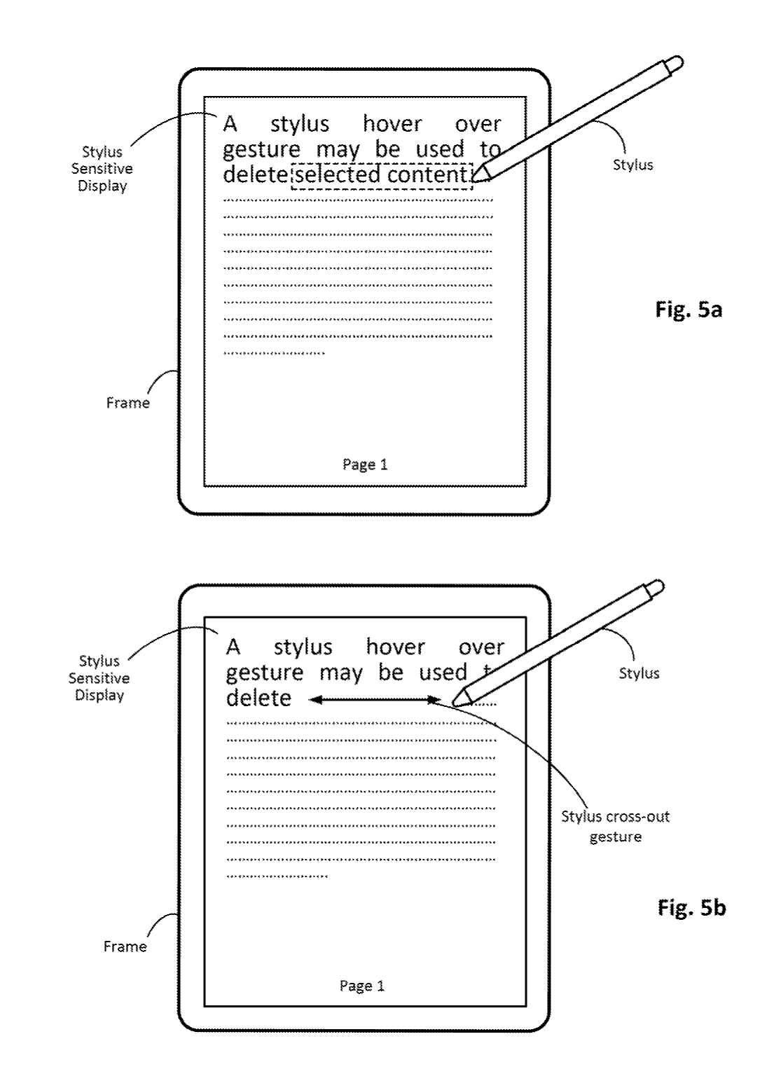

FIGS. 5a-b illustrate an example of an electronic stylus sensitive device and stylus wherein a stylus hover over gesture deletes content, in accordance with an embodiment of the present invention. As seen in this example, a stylus sensitive display screen is displaying a selection of text. The text could be, for example, a page of handwritten notes, a word document, or any other selection of text this is editable. Alternatively, the stylus hover over gesture may be configured to delete entire files or any other content. In the example shown in FIG. 5a, the user is viewing page 1 of the text and has selected the text outlined in the dashed line. Such optional highlighting may assist the user in identifying what file or application will be deleted before performing the gesture. The text may be selected in any suitable manner using the stylus, the user's finger, or any other selection method (note that selection of the content may have been pre-established prior to the delete action, or at the same time as the delete action such as the case when the stylus is pointing at the target content to be acted upon in response to the hovering gesture). In this particular example, the cross-out hover over gesture is associated with deleting content (e.g. hard-coded or via a configuration sub-menu) and the content to be deleted is selected and highlighted. As can be seen in reference to FIG. 5b, when the user performs the cross-out gesture while the stylus is hovering above the device the selected content is deleted. In this particular embodiment, the cross-out gesture includes two horizontal strokes of the stylus back and forth above the words that are intended to be deleted, as if the user were crossing out those words. In other embodiments, the cross-out gesture may include fewer or more strokes along the same line.

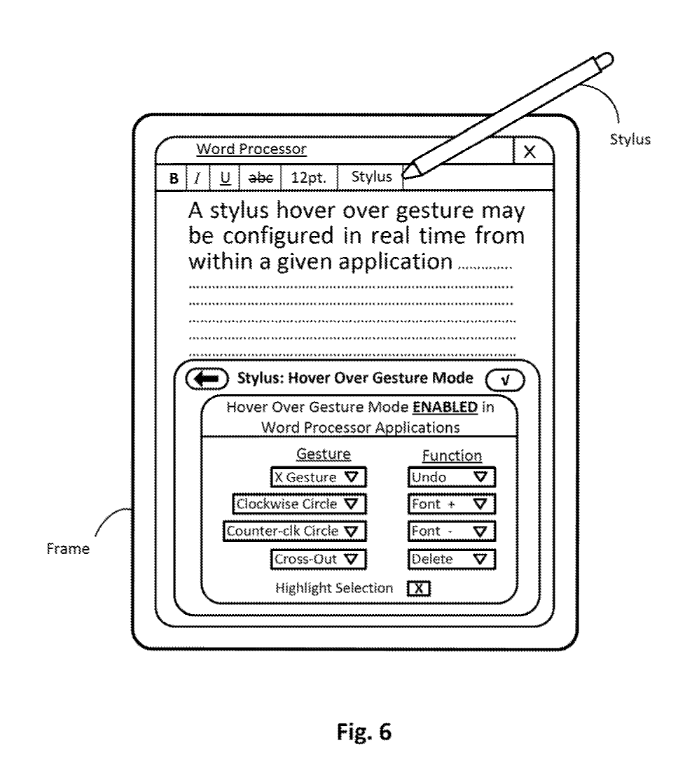

FIG. 6 illustrates an example of an electronic stylus sensitive device and stylus wherein a stylus hover over gesture mode may be configured in real-time on an application specific level, in accordance with an embodiment of the present invention. As seen in this example, a stylus sensitive display screen is displaying a selection of text in a word processor application. In the example shown in FIG. 6, the user is viewing page 1 of the text and the word processor includes an upper toolbar at the top of the page which includes a stylus icon, along with other standard word processing tool icons. In this particular example, selecting the stylus icon opens a stylus hover over gesture configuration sub-menu. The stylus icon may be selected using any means, including the stylus, a finger tap, or other appropriate selection technique. Such a sub-menu may customize the stylus hover over gestures within the word processor application. This example embodiment allows the user to configure gestures on an application specific level. As shown, the user in this example has associated the X gesture with undo, the clockwise circular gesture with increasing font size, the counter-clockwise circular gesture with decreasing font size, and the cross-out gesture with delete. Other example applications that may benefit from real-time application specific stylus hover over gesture configuration include eBooks, photo viewers, browsers, file managers, and video players, just to name a few.

Methodology

FIG. 7 illustrates a method for performing a stylus gesture while the stylus is hovering above the surface of an electronic stylus sensitive device, in accordance with an embodiment of the present invention. This example methodology may be implemented, for instance, by the UI module of the electronic computing device shown in FIG. 2a. To this end, the UI module can be implemented in software, hardware, firmware, or any combination thereof, as will be appreciated in light of this disclosure. The various stylus hover over actions may be communicated to the device over a communication link (e.g., EMR link, and/or dedicated communication link such as NFC or Bluetooth).

In general, any stylus sensitive surface may be used to detect the stylus hovering over the device. As discussed above, EMR or other suitable technology may be implemented to detect the presence of a stylus hovering over a stylus sensitive display, as well as to conmmnunicate stylus gestures to the electronic device. In one particular example, EMR technology may be implemented to power and/or track a stylus hovering over a stylus sensitive display. In one such example, a stylus gesture may manipulate the resonant frequency of a resonant circuit within the stylus. This change in resonant frequency may be detected by the antenna coils of the stylus detection grid of the device, thus triggering a response at the device. Various stylus gestures may create different changes in resonant frequency at the device, and thus may be assigned distinct functions. To this end, stylus angle detections can be used to implement UI functionality.

In this example case, the method includes monitoring 701 whether stylus input has been received, which may include input received when the stylus is hovering over or is otherwise sufficiently proximate to the stylus detection surface. In some embodiments, monitoring for stylus input includes monitoring all or part of a stylus sensitive display screen. In general, the stylus-based input monitoring is effectively continuous, and once a stylus input has been detected, the method may continue with determining 702 whether a non-contact stylus gesture has been performed. Example such gestures may include a clockwise or counter-clockwise circular gesture, a flick gesture, a swipe gesture, a cross-out gesture, a Z-shaped gesture, an X-shaped gesture, a stare point (where the stylus stares at a given point on the stylus detection surface), a combination of such gestures, or any other uniquely identifiable stylus motion performed while hovering the stylus above the detection surface. If no touch-free stylus gesture has been performed, the method may continue with reviewing 703 the stylus hover over gesture for other UI requests (such as control feature based stylus input). If a non-contact stylus control feature gesture has been performed, the method may continue with determining 704 whether the touch-free stylus input gesture is associated with a global function. If the touch-free stylus input gesture is associated with a global function, the method may continue with performing 705 the global function. If the stylus gesture is not associated with a global function, the method may continue with determining 706 whether the stylus is pointing to selected content on the electronic device. In some embodiments, the selected content may include, for example, a section of text, a selected file or application, or any other selected content displayed on the electronic device. Note that in some cases, the mere act of pointing the stylus at the target content effectively amounts to selecting that content, without anything further (e.g., no highlighting). If the stylus is pointing to selected content on the electronic device, the method may continue with performing 707 a desired function on the selected content. The desired function may be hard-coded or user-configurable and examples may include deleting the selected text or file, running the selected application, increasing font size, or any other action that may be performed on the selected content. If the stylus is not pointing at selected content on the electronic device, the method may continue with determining 708 whether the stylus is pointing to a UI control feature or UI icon. The UI control feature or icon may include, for example, a volume icon, a slide bar, a brightness indicator, a tap point graphic, etc. If the stylus is pointing to a UI control feature or icon, the method may continue with performing 709 a function associated with the UI control feature or icon. Functions associated with UI control features or icons, for example, may include increasing or decreasing volume, increasing or decreasing brightness, selecting a tap point graphic, scrolling through a list of content, etc. If the stylus is not pointing at a UI control feature or icon, the method may continue with determining 710 whether the stylus gesture is location sensitive. If the stylus gesture is location sensitive, the method may continue with performing 711 a function associated with the location sensitive area of the electronic device. A location sensitive stylus gesture, for example, may include a stylus gesture hovering over the right side of a display which turns to the next page of an eBook application. Many other location sensitive stylus hover over gestures will be apparent in light of this disclosure. If the stylus gesture is not location sensitive, the method may continue with determining 712 whether the stylus gesture is associated with a custom function. If the stylus gesture is associated with a custom function, the method may continue with performing 713 the custom function. If the stylus gesture is not associated with a custom function, the method may continue with performing 714 a default hover over stylus function. After any of the stylus functions has been performed, the method may continue with further monitoring 701 whether a stylus is hovering over a stylus detection surface.

Numerous variations and embodiments will be apparent in light of this disclosure. One example embodiment of the present invention provides a system including an electronic device having a display for displaying content to a user. The system also includes a stylus detection surface for allowing user input via a stylus. The system also includes a user interface executable on the electronic device and comprising a stylus hover over mode, wherein the stylus hover over mode is configured to perform a function on the device in response to a stylus gesture that does not directly touch the stylus detection surface. In some cases, the stylus gesture is user-configurable. In some cases, the stylus detection surface includes at least one set of antenna coils configured to detect changes in a resonant circuit within the stylus. In some such cases, the stylus detection surface further includes a second set of antenna coils configured to detect at least one of stylus location, speed of stylus movement, angle of stylus inclination and/or a change in resonant frequency of the resonant circuit within the stylus. In some cases, the system includes the stylus, and the stylus includes at least one control feature including at least one of a button, a rotating knob, a switch, a touch-sensitive area, a pressure-sensitive area, and/or a sliding control switch. In some such cases, the electronic device is configured to communicate with the stylus over a wireless communication link. In some such cases, the stylus can be configured in real-time over the wireless communication link. In some cases, the stylus detection surface detects a stylus gesture by detecting a change in resonant frequency of the stylus. In some cases, the stylus detection surface detects a stylus gesture by tracking the location of a resonant circuit within the stylus. In some cases, the function performed by the stylus hover over mode is user-configurable. In some cases, the electronic device is further configured to provide at least one of an audio and/or visual notification associated with a function. In some cases, the function performed by the stylus hover over mode is determined based on a stylus location over the stylus detection surface. In some cases, the display is a touch screen display and includes the stylus detection surface. In some cases, the electronic device is an eReader device or a tablet computer or a smartphone. In some cases, the stylus gesture and corresponding function include at least one of: a z-shaped gesture for undoing a previous action; a cross-out gesture for deleting content; a flick gesture for navigating content; a circle gesture for changing a device parameter value or launching a device menu or application; a stare gesture for selecting a user interface control feature or icon or content on the device; and/or a stare-flick combination gesture for causing a parameter change or launching a device menu.

Another example embodiment of the present invention provides a system including an electronic device having a display for displaying content to a user. The system also includes a stylus detection surface for allowing user input. The system also includes a stylus configured to communicate with the electronic device via the stylus detection surface. The system also includes a user interface executable on the device and including a stylus hover over mode, wherein the stylus hover over mode is configured to perform a function on the device in response to a stylus gesture that does not directly touch the stylus detection surface.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to display content to a user via a device having a stylus detection surface for allowing user input via a stylus; and perform a function in response to a stylus gesture that does not directly touch the stylus detection surface. In some cases, the function includes at least one of performing an undo action, performing a redo action, launching a note taking application, opening a tools menu, deleting content, adjusting screen brightness, adjusting volume, recording a sound and/or images, navigating content, interacting with a user interface menu, or switching from a first tool to a second tool. In some cases, the stylus detection surface detects a stylus gesture by tracking the location of a resonant circuit within the stylus. In some cases, the stylus detection surface detects a stylus gesture by detecting a change in resonant frequency of the stylus.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system, comprising:
an electronic device having a display for displaying content to a user and a stylus detection surface for allowing user input via a stylus; and
a user interface executable on the electronic device and comprising a stylus hover over mode, wherein the stylus hover over mode is configured to perform a function on the device in response to a stylus gesture that does not directly touch the stylus detection surface.

2. The system of claim 1 wherein the gesture is user-configurable.

3. The system of claim 1 wherein the stylus detection surface comprises at least one set of antenna coils configured to detect changes in a resonant circuit within the stylus.

4. The system of claim 3 wherein the stylus detection surface further comprises a second set of antenna coils configured to detect at least one of location, speed of stylus movement, angle of stylus inclination and/or a change in resonant frequency of the resonant circuit within the stylus.

5. The system of claim 1 further comprising the stylus, wherein the stylus includes at least one control feature including at least one of a button, a rotating knob, a switch, a touch-sensitive area, a pressure-sensitive area, and/or a sliding control switch.

6. The system of claim 5 wherein the electronic device is configured to communicate with the stylus over a wireless communication link.

7. The system of claim 6 wherein the stylus can be configured in real-time over the wireless communication link.

8. The system of claim 1 wherein the stylus detection surface detects a stylus gesture by detecting a change in resonant frequency of the stylus.

9. The system of claim 1 wherein the stylus detection surface detects a stylus gesture by tracking the location of a resonant circuit within the stylus.

10. The system of claim 1 wherein the function performed by the stylus hover over mode is user-configurable.

11. The system of claim 1 wherein the electronic device is further configured to provide at least one of an audio and/or visual notification associated with a function.

12. The system of claim 1 wherein the function performed by the stylus hover over mode is determined based on a stylus location over the stylus detection surface.

13. The system of claim 1 wherein the display is a touch screen display and includes the stylus detection surface.

14. The system of claim 1 wherein the electronic device is an eReader device or a tablet computer or a smartphone.

15. The system of claim 1 wherein the stylus gesture and corresponding function include at least one of: a z-shaped gesture for undoing a previous action: a cross-out gesture for deleting content; a flick gesture for navigating content; a circle gesture for changing a device parameter value or launching a device menu or application; a stare gesture for selecting a user interface control feature or icon or content on the device; and/or a stare-flick combination gesture for causing a parameter change or launching a device menu.

16. A system, comprising:
an electronic device having a display for displaying content to a user and a stylus detection surface for allowing user input;
a stylus configured to communicate with the electronic device via the stylus detection surface; and
a user interface executable on the device and comprising a stylus hover over mode, wherein the stylus hover over mode is configured to perform a function on the device in response to a stylus gesture that does not directly touch the stylus detection surface.

17. A computer program product comprising a plurality of instructions non-transiently encoded thereon to facilitate operation of an electronic device according to the following process, the process comprising:
display content to a user via a device having a stylus detection surface for allowing user input via a stylus; and
perform a function in response to a stylus gesture that does not directly touch the stylus detection surface.

18. The computer program product of claim 17 wherein the function comprises at least one of performing an undo action, performing a redo action, launching a note taking application, opening a tools menu, deleting content, adjusting screen brightness, adjusting volume, recording a sound and/or images, navigating content, interacting with a user interface menu, or switching from a first tool to a second tool.

19. The computer program product of claim 17 wherein the stylus detection surface detects a stylus gesture by tracking the location of a resonant circuit within the stylus.

20. The computer program product of claim 17 wherein the stylus detection surface detects a stylus gesture by detecting a change in resonant frequency of the stylus.
